(19) United States
(12) Patent Application Publication
(10) Pub. No.: US 2017/0260725 A1
(43) Pub. Date: Sep. 14, 2017

(54) Valve

(71) Applicant: McAlpine & Co. Ltd.

(72) Inventor: James Edward McAlpine, Paisley (GB)

(21) Appl. No.: 15/520,460

(22) PCT Filed: Oct. 20, 2015
(86) PCT No.: PCT/GB2015/053123

§ 371 Date: Apr. 20, 2017

(30) Foreign Application Priority Data
Oct. 20, 2014 (GB) 1418620.9

(51) Int. Cl. E03C 1/298; E03C 1/22; F16K 15/14

(52) U.S. Cl. CPC E03C 1/298; F16K 15/147; E03C 1/22

(57) ABSTRACT

The present invention provides an in-line valve particularly suitable for draining facilities to avoid odour penetrating habitable spaces or backflush of drainage liquids. The in-line valve comprises a body, preferably made of two engageable parts, an inset and a duckbill valve. The insert is located within the valve body and surrounding the duckbill valve. The insert funnels liquid from the valve inlet to the valve outlet, so that puddling in the valve body is avoided and therefore no water is accumulated, which could lead to odours or microorganisms proliferation.

### FIELD OF THE INVENTION

The present invention relates to the technical field of plumbing, particularly, but not limited, to residential drainage fittings, although it can also find application in any kind of drainage conduction. The present invention is particularly suitable for easy connection of the drainage piping of a building and is especially suitable to prevent backflow, unpleasant odours in buildings and sewer creatures crawling up the drain pipes.

### BACKGROUND TO THE INVENTION

One way in-line drain valves are commonly used nowadays for preventing backflow of drainage liquids, unpleasant odours migrating towards the interior of buildings and animals crawling up from the sewer system into buildings.

To accommodate the one-way valve 510 (See FIG. 1), the in-line drain valve body 502 has to be wider than the downstream pipe 504 and the upstream pipe 506 to which it is connected. When the in-line drain valve is used in a vertical orientation this is of no consequence, however, when the in-line drain valve 500 is used in a partially or fully horizontal orientation, liquid 508 flowing through the valve may gather in the wider section of the in-line drain valve body 502. This phenomenon is known as puddling in the valve and is perceived as an undesirable feature of in-line drain valve connections.

To solve the problem of puddling, in-line drain valves have been developed wherein the valve outlet is offset from the valve symmetry axis so that one side of the valve body is common to the outlet and there is no step in which liquid can remain trapped and produce puddling.

However, this solution requires that the valve must be rotationally oriented so that the outlet and valve body common side is in the lowest possible position, when the valve is not essentially vertically positioned.

This drawback can be solved by providing an independently rotatable threaded flange section at one end of the valve body. However, this independently rotatable threaded section is a potential source of leaks and odours and it is not an hermetic closure.

### SUMMARY OF THE INVENTION

According to a first aspect of the invention there is provided an in-line valve comprising:

a valve body comprising a valve body inlet and a valve body outlet, the valve body inlet and the valve body outlet having a common longitudinal axis with the valve body, the valve body defining a chamber, the chamber having a cross-sectional area larger than the cross-sectional area of the valve body outlet;

a duckbill valve, the duckbill valve having an inlet and an outlet; and

an insert, the insert having an inlet and an outlet, the insert being located within the chamber and being adapted to house the duckbill valve, the insert defining a flow path between the valve body inlet and the valve body outlet such that a first side and a second opposite side of the insert funnel the flow path to an equal or narrower dimension than the valve body outlet.

In at least one embodiment of the invention, by providing an in-line drain valve with an insert that comprises a first side and a second opposite side that funnel the flow path between the valve body inlet and the valve body outlet to an equal or narrower dimension than the valve body outlet, the in-line drain one-way valve can be installed to avoid puddling much more easily and hermetically than with prior art systems. In particular, the in-line valve can be installed in two different rotational orientations in which puddling is avoided, whereas in prior art systems, only one valve rotational orientation is able to prevent puddling.

Preferably the insert inlet is equal or larger than the valve body inlet. In at least one embodiment of the present invention, an insert with an inlet with the same or larger dimensions than the valve body inlet guarantees that no puddling can take place upstream of the insert.

Preferably the insert outlet is equal or smaller than the valve body outlet.

In at least one embodiment of the present invention, an insert with an outlet with the same or smaller dimensions than the valve body outlet guarantees that no puddling can take place within the valve body or within the insert

The insert inlet may comprise a flange. The insert outlet may comprise a flange at least partially surrounding the insert outlet. In at least one embodiment of the present invention by providing flanges to the insert inlet and/or the insert outlet enables the insert to define a more hermetic flow path between the valve body inlet and the valve body outlet because then it is easier for the insert to engage with the valve body inlet and valve body outlet.

The in-line valve may comprise a seal between the flange at least partially surrounding the insert outlet and the valve body. In at least one embodiment of the present invention a seal placed between the flange at least partially surrounding the insert outlet and the valve body effectively seals the gap between the insert outlet and the valve body and avoids leaks towards the valve body from inside the insert.

Preferably the valve body comprises two portions; an inlet portion and an outlet portion. The inlet portion and the outlet portion may be engageable between them.

In at least one of the embodiments of the present invention, a valve body comprising two portions engageable between them facilitates the assembling of the valve.

The insert inlet or its flange may be engageable with the valve body. The insert outlet or its at least partially surrounding flange may be engageable with the valve body.

In at least one embodiment of the present invention, when the insert inlet or its flange is engageable with the valve body and/or when the insert outlet or its flange is engageable with the valve body, it is less likely that, in use, liquid leaks from the interior of the insert towards the valve body.

Optionally the insert outlet may extend into the valve body outlet.

In at least one embodiment of the present invention when the insert outlet extends into the valve body outlet it is less likely that, in use, liquid leaks from the insert interior towards the valve body.

Part of the duckbill valve may be secured between the insert inlet and the valve body.

In at least one embodiment of the present invention when the duckbill valve is secured between the insert inlet and the valve body, it is less likely that, in use, liquid leaks from the interior of the insert towards the valve body.

According to a second aspect of the invention there is provided an insert for an in-line valve, the insert comprising:

an inlet; and

an outlet,

wherein the insert defines a flow path between the inlet and the outlet and wherein a first side and a second opposite side of the insert funnel the flow path to an equal or narrower dimension than the outlet.

Embodiments of the second aspect of the invention may comprise one or more features of the first aspect of the invention or its embodiments, or vice versa.

### BRIEF DESCRIPTION OF THE DRAWINGS

Embodiments of the present invention will now be described, by way of example only, with reference to the accompanying drawings, in which:

FIG. 1 shows a side view of an in-line one-way drain valve as encountered in the prior art with accumulated liquid within the valve body.

FIG. 2 shows a side view of an improved in-line one way drain valve according to an embodiment of the present invention.

FIG. 3 shows a perspective view of a second embodiment of the invention.

FIG. 4 shows a perspective view of a third embodiment of the invention.

FIG. 5 shows a perspective view of a fourth embodiment of the invention.

FIG. 6 shows a perspective view of a fifth embodiment of the invention.

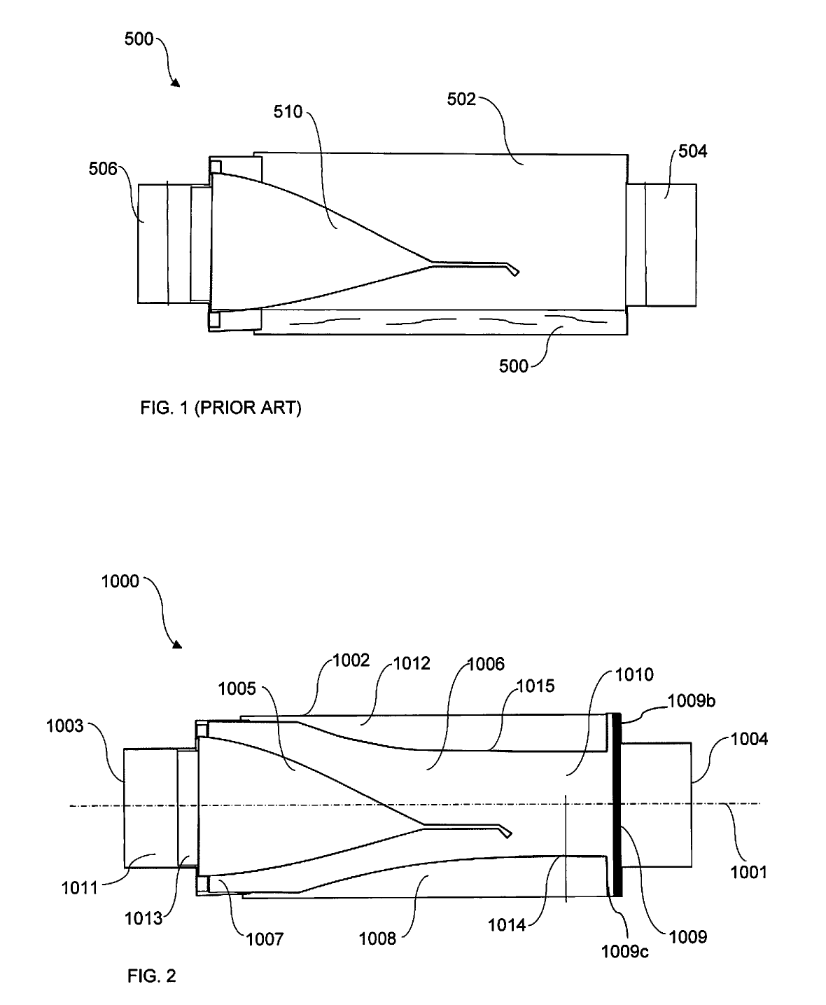

### DETAILED DESCRIPTION OF THE DRAWINGS

Referring to FIG. 2 an embodiment according to the first aspect of the present invention will be described.

This embodiment is an in-line valve 1000. The in-line valve 1000 comprises a valve body 1002. The valve body 1002 comprises a valve body inlet 1003 and a valve body outlet 1004. The valve body inlet 1003 and the valve body outlet 1004 have a common longitudinal axis 1001 with the valve body 1002. The valve body 1002 defines a chamber 1008 and the chamber 1008 has a cross-sectional area larger than the cross-sectional area of the valve body outlet 1004. The in-line valve 1000 further comprises a duckbill valve 1005. The duckbill valve 1005 has an inlet and an outlet. The in-line valve 1000 further comprises an insert 1006. The insert 1006 has an inlet 1007 and an outlet 1009. The insert 1006 is located within the chamber 1008 and is adapted to house the duckbill valve 1005. The insert 1006 defines a flow path 1010 between the valve body inlet 1003 and the valve body outlet 1004 such that a first side 1014 and a second opposite side 1015 of the insert 1006 funnel the flow path 1010 to an equal or narrower dimension than the valve body outlet 1004.

In this embodiment the valve body 1002 comprises two portions: an inlet portion 1011 and an outlet portion 1012. The outlet portion 1012 can be threaded onto the inlet portion 1011. This facilitates the assembling of the in-line valve 1000.

The assembling of the in-line valve comprises the following sequence: first, the duckbill 1005 valve is fitted onto a support 1013. Then, the support 1013 and duckbill valve 1005 are inserted into the valve body inlet portion 1011. Then the insert 1006 is placed into the valve body inlet portion 1011, surrounding the duckbill valve 1005. Finally the valve body outlet portion 1012 is threaded onto the valve body inlet portion 1011.

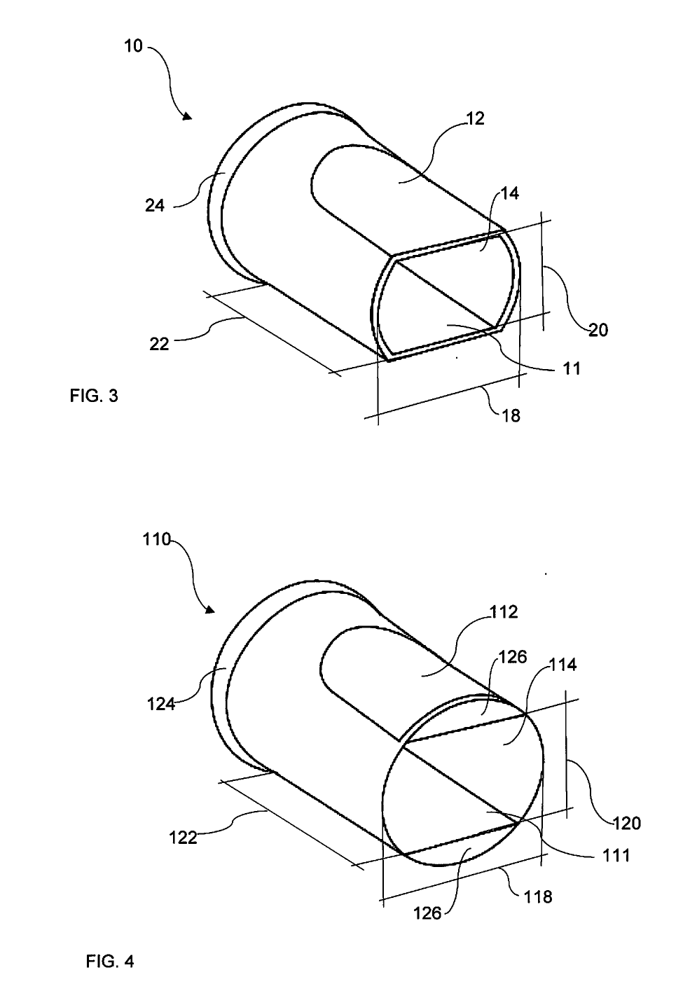

Referring to FIG. 3 an insert for an in-line one way drain valve will be described. The insert 10 has an inlet (not visible) and an outlet 14. The insert 10 defines a flow path between the inlet (not visible) and the outlet 14. A first side 11 and a second opposite side 12 of the insert funnel the flow path to an equal dimension than the outlet 14.

The insert 10 is made of rigid polypropylene (PP) by extrusion and blow moulding although other materials and fabrication techniques may be used.

The insert inlet (not visible) is 40 mm of internal diameter, the insert has a maximum width 18 of 40 mm and a minimum width 20 of 20 mm towards the insert outlet 14. The insert outlet 14 has also a maximum width of 40 mm and a minimum width of 20 mm.

The insert inlet (not visible) has a flange 24 of 46 mm of diameter and is 8 mm long.

The insert length 22 is 120 mm and the insert wall thickness is 1.5 mm.

Other dimensions may be used without departing from the principles of the invention.

Referring now to FIG. 4 another insert 110 for an in-line one way drain valve will be described.

Features in FIG. 4 equivalent to those of FIG. 3 are identified by the same numerals incremented by 100.

This embodiment is similar to the embodiment of FIG. 3 but in this case, the insert outlet 114 has two flange sections 126 that together with the insert outlet 114 form a circle with the same diameter than the interior of the in-line one way drain valve. This shape at the insert outlet 114 enhances the engageability of the insert 110 with an in-line valve.

Other dimensions may be used without departing from the principles of the invention.

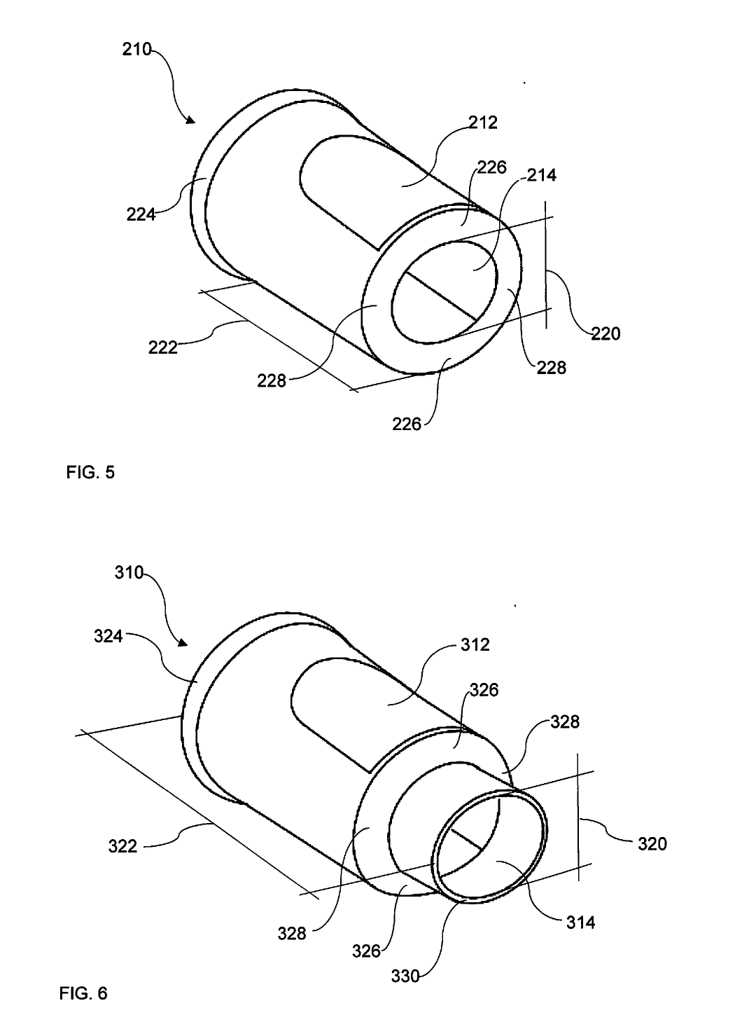

Referring now to FIG. 5 another insert for an in-line one way drain valve will be described.

Features in FIG. 5 equivalent to those of FIG. 3 are identified by the same numerals incremented by 200.

This embodiment is similar than the embodiment of FIG. 4 but in this case, the insert outlet 214 also has two adjacent portions of material 228 that restrict its dimensions to a circle of 20 mm of diameter. These reduced dimensions of the insert outlet 214 reduce the likelihood of leaks towards the in-line valve body.

Other dimensions may be used without departing from the principles of the invention.

Referring now to FIG. 6 another insert for an in-line one way drain valve will be described.

Features in FIG. 6 equivalent to those of FIG. 3 are identified by the same numerals incremented by 300.

This embodiment is similar than the embodiment of FIG. 5 but this embodiment comprises a tubular protrusion 330 that can be fitted into an in-line one way drain valve outlet and therefore it is less likely that, in use, liquid flowing through the insert leaks into the in-line valve body. The insert length 322 is 140 mm.

Other dimensions may be used without departing from the principles of the invention.

1. An in-line valve comprising:
a valve body comprising a valve body inlet and a valve body outlet, the valve body inlet and the valve body outlet having a common longitudinal axis with the valve body, the valve body defining a chamber, the chamber having a cross-sectional area larger than the cross-sectional area of the valve body outlet;
a duckbill valve, the duckbill valve having an inlet and an outlet; and
an insert, the insert having an inlet and an outlet, the insert being located within the chamber and being adapted to house the duckbill valve, the insert defining a flow path between the valve body inlet and the valve body outlet such that a first side and a second opposite side of the insert funnel the flow path to an equal or narrower dimension than the valve body outlet.

2. An in-line valve according to claim 1 wherein the insert inlet is equal or larger than the valve body inlet.

3. An in-line valve according to claim 1 wherein the insert outlet is equal or smaller than the valve body outlet.

4. An in-line valve according to claim 1 wherein the insert inlet comprises a flange.

5. An in-line valve according to claim 1 wherein the insert outlet comprises a flange at least partially surrounding the insert outlet.

6. An in-line valve according to claim 5 comprising a seal between the flange at least partially surrounding the insert outlet and the valve body.

7. An in-line valve according to claim 1 wherein the valve body comprises two portions: an inlet portion and an outlet portion.

8. An in-line valve according to claim 7 wherein the inlet portion and the outlet portion are engageable between them.

9. An in-line valve according to claim 4 wherein the insert inlet or its flange are engageable with the valve body.

10. An in-line valve according to claim 5 wherein the insert outlet or its at least partially surrounding flange are engageable with the valve body.

11. An in-line valve according to claim 1 wherein the insert outlet extends into the valve body outlet.

12. An in-line valve according to claim 1 wherein part of the duckbill valve is secured between the insert inlet and the valve body.

13. An insert for an in-line valve, the insert comprising:
an inlet; and
an outlet,
wherein the insert defines a flow path between the inlet and the outlet and wherein a first side and a second opposite side of the insert funnel the flow path to an equal or narrower dimension than the outlet.

14. An in-line valve comprising:
a valve body comprising a valve body inlet and a valve body outlet, the valve body inlet and the valve body outlet having a common longitudinal axis with the valve body, the valve body defining a chamber, the chamber having a cross-sectional area larger than the cross-sectional area of the valve body inlet; and
a duckbill valve, the duckbill valve having an inlet and an outlet, the valve body defining a retainer upstream of the chamber to retain the duckbill valve, the duckbill valve being arranged to extend into the chamber such that in use the duckbill valve can expand to maximise the flow through the valve.

15. An in-line valve according to claim 1 wherein the insert inlet is equal or larger than the valve body inlet, and wherein the insert outlet is equal or smaller than the valve body outlet.

16. An in-line valve according to claim 1 wherein the insert inlet comprises a flange, wherein the insert outlet comprises a flange at least partially surrounding the insert outlet, wherein the insert outlet or its at least partially surrounding flange are engageable with the valve body, and wherein the insert outlet extends into the valve body outlet.

17. An in-line valve according to claim 1 wherein the insert inlet is equal or larger than the valve body inlet, wherein the insert outlet is equal or smaller than the valve body outlet, wherein the insert inlet comprises a flange, wherein the insert outlet comprises a flange at least partially surrounding the insert outlet, wherein the insert outlet or its at least partially surrounding flange are engageable with the valve body, and wherein the insert outlet extends into the valve body outlet.

18. An in-line valve according to claim 1 wherein the insert outlet is equal or smaller than the valve body outlet, wherein the insert outlet comprises a flange at least partially surrounding the insert outlet, and wherein the insert outlet extends into the valve body outlet.

19. An in-line valve according to claim 1 wherein the insert inlet is equal or larger than the valve body inlet, wherein the insert outlet comprises a flange at least partially surrounding the insert outlet, and wherein part of the duckbill valve is secured between the insert inlet and the valve body.

20. An in-line valve according to claim 1 wherein the insert inlet is equal or larger than the valve body inlet, wherein the insert outlet is equal or smaller than the valve body outlet, wherein the insert inlet comprises a flange, wherein the insert outlet comprises a flange at least partially surrounding the insert outlet, wherein the valve body comprises two portions: an inlet portion and an outlet portion, wherein the insert outlet extends into the valve body outlet, and wherein part of the duckbill valve is secured between the insert inlet and the valve body.
